(19) United States
(12) Patent Application Publication
(10) Pub. No.: US 2026/0246683 A1
(43) Pub. Date: Aug. 20, 2026

(54) TRANSMITTING DATA IN HEAD AND/OR TAIL OF SINGLE CARRIER WAVEFORM SYMBOL

(71) Applicant: Nokia Technologies Oy, Espoo (FI)

(72) Inventors: Oskari TERVO, Oulu (FI); Esa Tapani TIIROLA, Oulu (FI); Ismael PERUGA NASARRE, Tampere (FI)

(21) Appl. No.: 18/870,359

(22) PCT Filed: Jun. 1, 2022
(86) PCT No.: PCT/EP2022/064921

§ 371 Date: Nov. 27, 2024

(51) Int. Cl. H04L 27/26; H04W 72/21

(52) U.S. Cl. CPC H04L 27/26134; H04L 27/2636; H04W 72/21

(57) ABSTRACT

Disclosed is a method comprising transmitting at least one single-carrier waveform symbol comprising at least one of a head sequence and/or a tail sequence, wherein at least a part of the head sequence and/or the tail sequence comprises data and/or control information.

### FIELD

The following example embodiments relate to wireless communication.

### BACKGROUND

As wireless communication systems are moving to higher frequencies, it is desirable to provide waveforms to better support these higher frequencies.

### BRIEF DESCRIPTION

The scope of protection sought for various example embodiments is set out by the independent claims. The example embodiments and features, if any, described in this specification that do not fall under the scope of the independent claims are to be interpreted as examples useful for understanding various embodiments.

According to an aspect, there is provided an apparatus comprising at least one processor, and at least one memory including computer program code, wherein the at least one memory and the computer program code are configured, with the at least one processor, to cause the apparatus to: transmit at least one single-carrier waveform symbol comprising at least one of a head sequence and/or a tail sequence, wherein at least a part of the head sequence and/or the tail sequence comprises data and/or control information.

According to another aspect, there is provided an apparatus comprising means for: transmitting at least one single-carrier waveform symbol comprising at least one of a head sequence and/or a tail sequence, wherein at least a part of the head sequence and/or the tail sequence comprises data and/or control information.

According to another aspect, there is provided a method comprising: transmitting at least one single-carrier waveform symbol comprising at least one of a head sequence and/or a tail sequence, wherein at least a part of the head sequence and/or the tail sequence comprises data and/or control information.

According to another aspect, there is provided a computer program comprising instructions which, when executed by an apparatus, cause the apparatus to perform at least the following: transmitting at least one single-carrier waveform symbol comprising at least one of a head sequence and/or a tail sequence, wherein at least a part of the head sequence and/or the tail sequence comprises data and/or control information.

According to another aspect, there is provided a computer program comprising instructions for causing an apparatus to perform at least the following: transmitting at least one single-carrier waveform symbol comprising at least one of a head sequence and/or a tail sequence, wherein at least a part of the head sequence and/or the tail sequence comprises data and/or control information.

According to another aspect, there is provided a computer readable medium comprising program instructions for causing an apparatus to perform at least the following: transmitting at least one single-carrier waveform symbol comprising at least one of a head sequence and/or a tail sequence, wherein at least a part of the head sequence and/or the tail sequence comprises data and/or control information.

According to another aspect, there is provided a non-transitory computer readable medium comprising program instructions for causing an apparatus to perform at least the following: transmitting at least one single-carrier waveform symbol comprising at least one of a head sequence and/or a tail sequence, wherein at least a part of the head sequence and/or the tail sequence comprises data and/or control information.

According to another aspect, there is provided an apparatus comprising at least one processor, and at least one memory including computer program code, wherein the at least one memory and the computer program code are configured, with the at least one processor, to cause the apparatus to: receive at least one single-carrier waveform symbol comprising at least one of a head sequence and/or a tail sequence, wherein at least a part of the head sequence and/or the tail sequence comprises data and/or control information.

According to another aspect, there is provided an apparatus comprising means for: receiving at least one single-carrier waveform symbol comprising at least one of a head sequence and/or a tail sequence, wherein at least a part of the head sequence and/or the tail sequence comprises data and/or control information.

According to another aspect, there is provided a method comprising: receiving at least one single-carrier waveform symbol comprising at least one of a head sequence and/or a tail sequence, wherein at least a part of the head sequence and/or the tail sequence comprises data and/or control information.

According to another aspect, there is provided a computer program comprising instructions which, when executed by an apparatus, cause the apparatus to perform at least the following: receiving at least one single-carrier waveform symbol comprising at least one of a head sequence and/or a tail sequence, wherein at least a part of the head sequence and/or the tail sequence comprises data and/or control information.

According to another aspect, there is provided a computer program comprising instructions for causing an apparatus to perform at least the following: receiving at least one single-carrier waveform symbol comprising at least one of a head sequence and/or a tail sequence, wherein at least a part of the head sequence and/or the tail sequence comprises data and/or control information.

According to another aspect, there is provided a computer readable medium comprising program instructions for causing an apparatus to perform at least the following: receiving at least one single-carrier waveform symbol comprising at least one of a head sequence and/or a tail sequence, wherein at least a part of the head sequence and/or the tail sequence comprises data and/or control information.

According to another aspect, there is provided a non-transitory computer readable medium comprising program instructions for causing an apparatus to perform at least the following: receiving at least one single-carrier waveform symbol comprising at least one of a head sequence and/or a tail sequence, wherein at least a part of the head sequence and/or the tail sequence comprises data and/or control information.

### LIST OF DRAWINGS

In the following, various example embodiments will be described in greater detail with reference to the accompanying drawings, in which

FIG. 1 illustrates an example embodiment of a cellular communication network;

FIG. 2 illustrates the difference between two symbol structures;

FIG. 3 illustrates a flow chart according to an example embodiment;

FIG. 4 illustrates a flow chart according to an example embodiment;

FIG. 5 illustrates an example of mixed modulations;

FIG. 6 illustrates a signaling diagram according to an example embodiment;

FIG. 7 illustrates a signaling diagram according to an example embodiment;

FIG. 8 illustrates a signaling diagram according to an example embodiment;

FIG. 9 illustrates an example of a single-carrier waveform symbol;

FIG. 10 illustrates an example of a single-carrier waveform symbol;

FIG. 11 illustrates an example of how the addition of known tail samples carrying data and/or control information affects the transport block size computation;

FIG. 12 illustrates an example of the transport block size computation, when a mixed modulation and coding scheme table indicates the modulation order for a first modulation and for a second modulation;

FIGS. 13a, 13b and 13c illustrate examples of how the known sequence length affects the maximum power reduction requirements;

FIG. 14 illustrates an example embodiment of an apparatus; and

FIG. 15 illustrates an example embodiment of an apparatus.

### DETAILED DESCRIPTION

The following embodiments are exemplifying. Although the specification may refer to “an”, “one”, or “some” embodiment(s) in several locations of the text, this does not necessarily mean that each reference is made to the same embodiment(s), or that a particular feature only applies to a single embodiment. Single features of different embodiments may also be combined to provide other embodiments.

In the following, different example embodiments will be described using, as an example of an access architecture to which the example embodiments may be applied, a radio access architecture based on long term evolution advanced (LTE Advanced, LTE-A), new radio (NR, 5G), beyond 5G, or sixth generation (6G) without restricting the example embodiments to such an architecture, however. It is obvious for a person skilled in the art that the example embodiments may also be applied to other kinds of communications networks having suitable means by adjusting parameters and procedures appropriately. Some examples of other options for suitable systems may be the universal mobile telecommunications system (UMTS) radio access network (UTRAN or E-UTRAN), long term evolution (LTE, substantially the same as E-UTRA), wireless local area network (WLAN or Wi-Fi), worldwide interoperability for microwave access (WiMAX), Bluetooth®, personal communications services (PCS), ZigBee®, wideband code division multiple access (WCDMA), systems using ultra-wideband (UWB) technology, sensor networks, mobile ad-hoc networks (MANETs) and Internet Protocol multimedia subsystems (IMS) or any combination thereof.

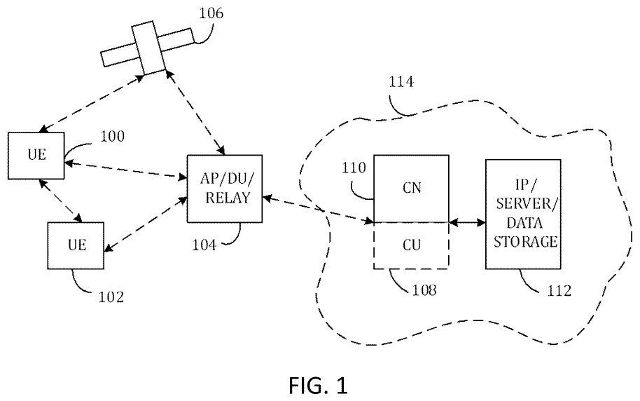

FIG. 1 depicts examples of simplified system architectures showing some elements and functional entities, all being logical units, whose implementation may differ from what is shown. The connections shown in FIG. 1 are logical connections; the actual physical connections may be different. It is apparent to a person skilled in the art that the system may also comprise other functions and structures than those shown in FIG. 1.

The example embodiments are not, however, restricted to the system given as an example but a person skilled in the art may apply the solution to other communication systems provided with necessary properties.

The example of FIG. 1 shows a part of an exemplifying radio access network.

FIG. 1 shows user devices 100 and 102 configured to be in a wireless connection on one or more communication channels in a radio cell with an access node 104, such as an evolved Node B (abbreviated as eNB or eNodeB) or a next generation Node B (abbreviated as gNB or gNodeB), providing the radio cell. The physical link from a user device to an access node may be called uplink (UL) or reverse link, and the physical link from the access node to the user device may be called downlink (DL) or forward link. A user device may also communicate directly with another user device via sidelink (SL) communication. It should be appreciated that access nodes or their functionalities may be implemented by using any node, host, server or access point etc. entity suitable for such a usage.

A communication system may comprise more than one access node, in which case the access nodes may also be configured to communicate with one another over links, wired or wireless, designed for the purpose. These links may be used for signaling purposes. The access node may be a computing device configured to control the radio resources of communication system it is coupled to. The access node may also be referred to as a base station, a base transceiver station (BTS), an access point or any other type of interfacing device including a relay station capable of operating in a wireless environment. The access node may include or be coupled to transceivers. From the transceivers of the access node, a connection may be provided to an antenna unit that establishes bi-directional radio links to user devices. The antenna unit may comprise a plurality of antennas or antenna elements. The access node may further be connected to a core network 110 (CN or next generation core NGC). Depending on the system, the counterpart on the CN side may be a serving gateway (S-GW, routing and forwarding user data packets), packet data network gateway (P-GW) for providing connectivity of user devices to external packet data networks, user plane function (UPF), mobility management entity (MME), access and mobility management function (AMF), or location management function (LMF), etc.

The user device illustrates one type of an apparatus to which resources on the air interface may be allocated and assigned, and thus any feature described herein with a user device may be implemented with a corresponding apparatus, such as a relay node.

An example of such a relay node may be a layer 3 relay (self-backhauling relay) towards the access node. The self-backhauling relay node may also be called an integrated access and backhaul (IAB) node. The IAB node may comprise two logical parts: a mobile termination (MT) part, which takes care of the backhaul link(s) (i.e., link(s) between IAB node and a donor node, also known as a parent node) and a distributed unit (DU) part, which takes care of the access link(s), i.e., child link(s) between the IAB node and user device(s), and/or between the IAB node and other IAB nodes (multi-hop scenario).

Another example of such a relay node may be a layer 1 relay called a repeater. The repeater may amplify a signal received from an access node and forward it to a user device, and/or amplify a signal received from the user device and forward it to the access node.

The user device may also be called a subscriber unit, mobile station, remote terminal, access terminal, user terminal, terminal device, or user equipment (UE) just to mention but a few names or apparatuses. The user device may refer to a portable computing device that includes wireless mobile communication devices operating with or without a subscriber identification module (SIM), including, but not limited to, the following types of devices: a mobile station (mobile phone), smartphone, personal digital assistant (PDA), handset, device using a wireless modem (alarm or measurement device, etc.), laptop and/or touch screen computer, tablet, game console, notebook, and multimedia device. It should be appreciated that a user device may also be a nearly exclusive uplink only device, of which an example may be a camera or video camera loading images or video clips to a network. A user device may also be a device having capability to operate in Internet of Things (IoT) network which is a scenario in which objects may be provided with the ability to transfer data over a network without requiring human-to-human or human-to-computer interaction. The user device may also utilize cloud. In some applications, a user device may comprise a small portable or wearable device with radio parts (such as a watch, earphones or eyeglasses) and the computation may be carried out in the cloud. The user device (or in some example embodiments a layer 3 relay node) may be configured to perform one or more of user equipment functionalities. The user device may also comprise, or be comprised in, a robot or a vehicle such as a train or a car.

Various techniques described herein may also be applied to a cyber-physical system (CPS) (a system of collaborating computational elements controlling physical entities). CPS may enable the implementation and exploitation of massive amounts of interconnected ICT devices (sensors, actuators, processors microcontrollers, etc.) embedded in physical objects at different locations. Mobile cyber physical systems, in which the physical system in question may have inherent mobility, are a subcategory of cyber-physical systems. Examples of mobile physical systems include mobile robotics and electronics transported by humans or animals.

Additionally, although the apparatuses have been depicted as single entities, different units, processors and/or memory units (not all shown in FIG. 1) may be implemented.

5G enables using multiple input-multiple output (MIMO) antennas, many more base stations or nodes than the LTE (a so-called small cell concept), including macro sites operating in co-operation with smaller stations and employing a variety of radio technologies depending on service needs, use cases and/or spectrum available. 5G mobile communications may support a wide range of use cases and related applications including video streaming, augmented reality, different ways of data sharing and various forms of machine type applications (such as (massive) machine-type communications (mMTC), including vehicular safety, different sensors and real-time control. 5G may have multiple radio interfaces, namely below 6 GHz, cmWave and mmWave, and also being integrable with existing legacy radio access technologies, such as the LTE. Integration with the LTE may be implemented, at least in the early phase, as a system, where macro coverage may be provided by the LTE, and 5G radio interface access may come from small cells by aggregation to the LTE. In other words, 5G may support both inter-RAT operability (such as LTE-5G) and inter-RI operability (inter-radio interface operability, such as below 6 GHz-cmWave-mmWave). One of the concepts considered to be used in 5G networks may be network slicing, in which multiple independent and dedicated virtual sub-networks (network instances) may be created within the substantially same infrastructure to run services that have different requirements on latency, reliability, throughput and mobility.

The current architecture in LTE networks may be fully distributed in the radio and fully centralized in the core network. The low latency applications and services in 5G may need to bring the content close to the radio which leads to local break out and multi-access edge computing (MEC). 5G may enable analytics and knowledge generation to occur at the source of the data. This approach may need leveraging resources that may not be continuously connected to a network such as laptops, smartphones, tablets and sensors. MEC may provide a distributed computing environment for application and service hosting. It may also have the ability to store and process content in close proximity to cellular subscribers for faster response time. Edge computing may cover a wide range of technologies such as wireless sensor networks, mobile data acquisition, mobile signature analysis, cooperative distributed peer-to-peer ad hoc networking and processing also classifiable as local cloud/fog computing and grid/mesh computing, dew computing, mobile edge computing, cloudlet, distributed data storage and retrieval, autonomic self-healing networks, remote cloud services, augmented and virtual reality, data caching, Internet of Things (massive connectivity and/or latency critical), critical communications (autonomous vehicles, traffic safety, real-time analytics, time-critical control, healthcare applications).

The communication system may also be able to communicate with other networks, such as a public switched telephone network or the Internet 112, or utilize services provided by them. The communication network may also be able to support the usage of cloud services, for example at least part of core network operations may be carried out as a cloud service (this is depicted in FIG. 1 by “cloud” 114). The communication system may also comprise a central control entity, or a like, providing facilities for networks of different operators to cooperate for example in spectrum sharing.

Edge cloud may be brought into radio access network (RAN) by utilizing network function virtualization (NFV) and software defined networking (SDN). Using edge cloud may mean access node operations to be carried out, at least partly, in a server, host or node operationally coupled to a remote radio head (RRH) or a radio unit (RU), or an access node comprising radio parts. It may also be possible that node operations are distributed among a plurality of servers, nodes or hosts. Carrying out the RAN real-time functions at the RAN side (in a distributed unit, DU 104) and non-real time functions in a centralized manner (in a central unit, CU 108) may be enabled for example by application of cloudRAN architecture.

It should also be understood that the distribution of labour between core network operations and access node operations may differ from that of the LTE or even be non-existent. Some other technology advancements that may be used include big data and all-IP, which may change the way networks are being constructed and managed. 5G (or new radio, NR) networks may be designed to support multiple hierarchies, where MEC servers may be placed between the core and the access node. It should be appreciated that MEC may be applied in 4G networks as well.

5G may also utilize non-terrestrial communication, for example satellite communication, to enhance or complement the coverage of 5G service, for example by providing backhauling. Possible use cases may be providing service continuity for machine-to-machine (M2M) or Internet of Things (IoT) devices or for passengers on board of vehicles, or ensuring service availability for critical communications, and future railway/maritime/aeronautical communications. Satellite communication may utilize geostationary earth orbit (GEO) satellite systems, but also low earth orbit (LEO) satellite systems, in particular mega-constellations (systems in which hundreds of (nano) satellites are deployed). At least one satellite 106 in the mega-constellation may cover several satellite-enabled network entities that create on-ground cells. The on-ground cells may be created through an on-ground relay node 104 or by a gNB located on-ground or in a satellite.

6G networks are expected to adopt flexible decentralized and/or distributed computing systems and architecture and ubiquitous computing, with local spectrum licensing, spectrum sharing, infrastructure sharing, and intelligent automated management underpinned by mobile edge computing, artificial intelligence, short-packet communication and blockchain technologies. Key features of 6G may include intelligent connected management and control functions, programmability, integrated sensing and communication, reduction of energy footprint, trustworthy infrastructure, scalability and affordability. In addition to these, 6G is also targeting new use cases covering the integration of localization and sensing capabilities into system definition to unifying user experience across physical and digital worlds.

It is obvious for a person skilled in the art that the depicted system is only an example of a part of a radio access system and in practice, the system may comprise a plurality of access nodes, the user device may have an access to a plurality of radio cells and the system may also comprise other apparatuses, such as physical layer relay nodes or other network elements, etc. At least one of the access nodes may be a Home eNodeB or a Home gNodeB.

Furthermore, the access node may also be split into: a radio unit (RU) comprising a radio transceiver (TRX), i.e., a transmitter (Tx) and a receiver (Rx); one or more distributed units (DUs) that may be used for the so-called Layer 1 (L1) processing and real-time Layer 2 (L2) processing; and a central unit (CU) (also known as a centralized unit) that may be used for non-real-time L2 and Layer 3 (L3) processing. The CU may be connected to the one or more DUs for example by using an F1 interface. Such a split may enable the centralization of CUs relative to the cell sites and DUs, whereas DUs may be more distributed and may even remain at cell sites. The CU and DU together may also be referred to as baseband or a baseband unit (BBU). The CU and DU may also be comprised in a radio access point (RAP).

The CU may be defined as a logical node hosting higher layer protocols, such as radio resource control (RRC), service data adaptation protocol (SDAP) and/or packet data convergence protocol (PDCP), of the access node. The DU may be defined as a logical node hosting radio link control (RLC), medium access control (MAC) and/or physical (PHY) layers of the access node. The operation of the DU may be at least partly controlled by the CU. The CU may comprise a control plane (CU-CP), which may be defined as a logical node hosting the RRC and the control plane part of the PDCP protocol of the CU for the access node. The CU may further comprise a user plane (CU-UP), which may be defined as a logical node hosting the user plane part of the PDCP protocol and the SDAP protocol of the CU for the access node.

Cloud computing platforms may also be used to run the CU and/or DU. The CU may run in a cloud computing platform, which may be referred to as a virtualized CU (vCU). In addition to the vCU, there may also be a virtualized DU (vDU) running in a cloud computing platform. Furthermore, there may also be a combination, where the DU may use so-called bare metal solutions, for example application-specific integrated circuit (ASIC) or customer-specific standard product (CSSP) system-on-a-chip (SoC) solutions. It should also be understood that the distribution of labour between the above-mentioned access node units, or different core network operations and access node operations, may differ.

Additionally, in a geographical area of a radio communication system, a plurality of different kinds of radio cells as well as a plurality of radio cells may be provided. Radio cells may be macro cells (or umbrella cells) which may be large cells having a diameter of up to tens of kilometers, or smaller cells such as micro-, femto- or picocells. The access node(s) of FIG. 1 may provide any kind of these cells. A cellular radio system may be implemented as a multilayer network including several kinds of radio cells. In multilayer networks, one access node may provide one kind of a radio cell or radio cells, and thus a plurality of access nodes may be needed to provide such a network structure.

For fulfilling the need for improving the deployment and performance of communication systems, the concept of “plug-and-play” access nodes may be introduced. A network which may be able to use “plug-and-play” access nodes, may include, in addition to Home eNodeBs or Home gNodeBs, a Home Node B gateway, or HNB-GW (not shown in FIG. 1). An HNB-GW, which may be installed within an operator's network, may aggregate traffic from a large number of Home eNodeBs or Home gNodeBs back to a core network.

In wireless communications, the phase noise from the transmitter and/or receiver radio frequency (RF) local oscillator (LO) may degrade the signal quality. Phase noise may increase by approximately 6 dB as the carrier frequency doubles. Therefore, phase noise may be more pronounced, for example, in the frequency range between 52.6 and 71 GHz (a.k.a. FR2-2) when compared to lower frequency bands (such as FR2-1). Similarly, phase noise may be even more pronounced in frequencies above 71 GHz. This may limit the use of high order modulations, and therefore decrease the spectrum efficiency of the system.

Higher sub-carrier spacing (SCS) may be used to reduce the phase noise effect. However, increasing the SCS may impact the system, since the bandwidth and symbol rate are increased. Therefore, faster processing may be needed. In addition, the time duration of the cyclic prefix (CP) decreases when the SCS is larger, and the CP overhead is maintained. The reduced CP may lead to radio link performance degradation due to inter-symbol interference induced by the frequency selective channel. With shorter symbol durations, the scheduling periods may become too short and control channel coverage may be degraded. In addition, reduced CP length may cause issues with beam switching, as the switch time may become longer than the CP duration. Apart from this, also higher power spectral densities (PSD) for transmitted signals with an equal number of sub-carriers are provided with smaller SCS, and the sampling rate is smaller, thus reducing the power consumption.

The current NR (up to Release 17) supports cyclic prefix orthogonal frequency division multiplexing (CP-OFDM) in downlink, and both CP-OFDM and discrete Fourier transform spread orthogonal frequency division multiplexing (DFT-s-OFDM) in uplink. DFT-s-OFDM may also be referred to as single-carrier frequency division multiple access (SC-FDMA), since the DFT-s-OFDM waveform is practically a single-carrier waveform. In DFT-s-OFDM, a time-domain phase tracking reference signal (PTRS) may be utilized to track the phase noise over time within the DFT-s-OFDM symbol and correct the received samples. In other words, a DFT-s-OFDM symbol may comprise one or more pilot sub-symbols (i.e., PTRS symbols) and one or more data sub-symbols. Herein sub-symbols refer to the group of modulation symbols that are part of a DFT-s-OFDM symbol. Pilot sub-symbols may be used for estimating phase noise and for other channel estimation purposes. Pilot sub-symbols comprise known data, i.e., known modulation symbols, which may be used to detect changes, such as phase noise, in the channel. The pilot sub-symbols are known at the receiver, and thus the receiver may compare the pilot sub-symbols comprised in a received signal against the known original pilot sub-symbols.

Currently, support for frequency range 2-2 (FR2-2), i.e., frequencies 52.6-71 GHz is being standardized in NR Release 17, with the main scenario being unlicensed band operation with relatively low effective isotropic radiated power (EIRP) (e.g., 40 dBm).

In NR Release 19 and beyond, even higher frequencies above 71 GHz may be supported. Therein, single-carrier waveform may be considered both in uplink and downlink, since it allows to reach a high EIRP (e.g., 60 dBm) with smaller power amplifier (PA) output backoff. Hence, single-carrier waveform allows to reduce the complexity of the hardware as well as power consumption. Furthermore, single-carrier waveforms may also be more robust to phase noise with low complexity.

The frequency bands above 71 GHz include, for example, the W-band (75 to 110 GHz) and D-band (110 to 170 GHz). In these frequency bands, the amount of spectrum is high, but there are also restrictions for the band usage, such as RR5.340 where all emissions are prohibited (passive satellite band).

The European telecommunications regulator CEPT ECC has approved two recommendations for fixed service (FS) above 92 GHz: the W Band ECC Recommendation ECC/REC/(18)02 on frequencies 92-114.25 GHz, and the D Band ECC Recommendation ECC/REC/(18)01 on frequencies 130-174.8 GHz.

One possible waveform candidate for these higher frequencies above 71 GHz is known tail DFT-s-OFDM (KT-DFT-s-OFDM). KT-DFT-s-OFDM may also be referred to as unique word DFT-s-OFDM. A difference between KT-DFT-s-OFDM and DFT-s-OFDM is that DFT-s-OFDM uses cyclic prefix (CP) to handle the delay spread, while in KT-DFT-s-OFDM, the cyclic prefix is replaced by an in-symbol known sequence (e.g., reference sub-symbols known also at the receiver) in the beginning and end of the KT-DFT-s-OFDM symbol, inserted prior to the discrete Fourier transform (DFT) operation at the transmitter. This provides several benefits such as:
Adjustable known tail (KT) length (i.e., the number of sub-symbols used for the head/beginning and tail/end of the KT-DFT-s-OFDM symbol), providing optimized spectrum efficiency depending on the case. The KT length may also be referred to as known sequence length, i.e., the length of at least one of the head sequence or the tail sequence. The length of the head sequence may be different or the same as the length of the tail sequence.
Peak-to-average-power ratio (PAPR) due to KT sub-symbols (reference sub-symbols) is reduced, since the known sequences can be designed to have near-to-constant envelope, providing increased transmit power (cyclic prefix creates phase/amplitude discontinuity, which has negative impact to the spectral properties of the signal).
PAPR can be further reduced using spectrum shaping techniques such as frequency-domain spectral shaping (FDSS) or FDSS with spectrum extension.
15-symbol slots, compared to 14-symbol slots (5G NR defines 14-symbol slots for normal CP).
Known sequence can be used for channel estimation and phase noise estimation, providing improved performance.

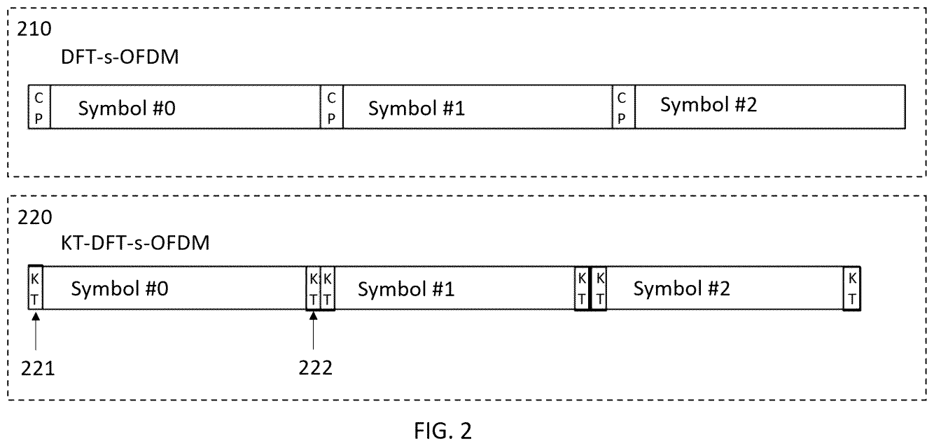

FIG. 2 illustrates the difference between DFT-s-OFDM symbol structure 210 and KT-DFT-s-OFDM symbol structure 220. In DFT-s-OFDM, the CP overhead is fixed, and the symbol is extended by it (after the inverse fast Fourier transform, IFFT). In KT-DFT-s-OFDM, there is a known sequence 221, 222 at the end (tail sequence 222) and the beginning (head sequence 221) of a KT-DFT-s-OFDM symbol (inserted before DFT), and the length of the known sequence can be adjusted. A known sequence may also be referred to as a KT sequence or a KT known sequence. The known sequences (in head and tail) may be assumed to be known at the receiver and have the purpose of reducing the PAPR of the waveform, and out-of-band emissions. In addition, there is no extra guard interval between the symbols. In other words, the usage of KT-DFT-s-OFDM may make the system more flexible to support different delay spreads without modifying the slot structure.

The design of KT-DFT-s-OFDM is different compared to the currently supported waveforms, because cyclic prefix is removed and replaced by an in-symbol known sequence in the head and tail of the KT-DFT-s-OFDM symbol. To provide more benefits of the waveform, the length of the known sequence(s) may be configurable (adjustable) for example by using RRC signaling. For example, the length of the known sequence(s) in pre-DFT symbols may be 4, 16, 64, 128, or 256. The length of the known sequence(s) refers to the number of sub-symbols assigned to the head and tail of the OFDM symbol before the DFT operation. For example, a KT-DFT-s-OFDM symbol may carry 50 sub-symbols, and if the known sequence length is set to 4, this means that 4 sub-symbols at the beginning (head) and 4 sub-symbols at the end (tail) of the KT-DFT-s-OFDM symbol would correspond to the known sequence. The length of the known sequence(s) may be selected based on the delay spread of the channel, or on a PAPR target for the waveform, which could result in a different maximum power reduction (MPR) target.

However, the known sequence(s) may also be used for other purposes, such as carrying control information or data. Thus, there is a challenge in how to design a system to make maximal use of the known sequence(s).

In some example embodiments, at least a part of the known sequence(s) is used or reserved for transmission of data and/or control information. Some example embodiments may be beneficial in downlink as well. In uplink, the control information may comprise uplink control information (UCI), such as hybrid automatic repeat request acknowledgement (HARQ-ACK) and/or channel state information (CSI). In downlink, the control information may comprise downlink control information (DCI).

Some example embodiments may provide improved coverage. Some example embodiments may also provide improved performance compared to legacy DFT-s-OFDM, with case optimized trade-off between KT overhead and coverage. Furthermore, some example embodiments may enable usage of mixed modulation and coding schemes (MCS) to achieve high spectral efficiency (property of a short known sequence) and high power efficiency (property of a long known sequence) at the same time.

Some example embodiments are described below using principles and terminology of 5G technology without limiting the example embodiments to 5G communication systems, however.

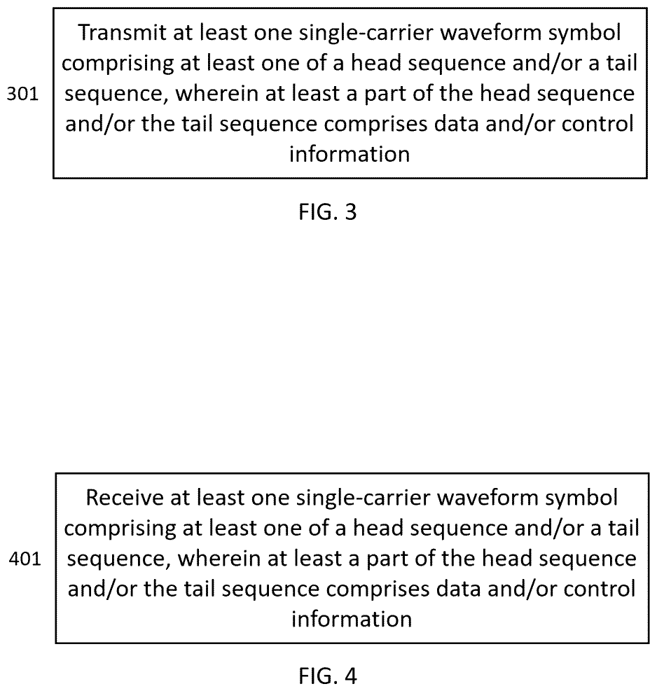

FIG. 3 illustrates a flow chart according to an example embodiment of a method performed by an apparatus such as, or comprising, or comprised in, a user device (in uplink scenario) or a network element of a radio access network (in downlink scenario). The user device may also be called a subscriber unit, mobile station, remote terminal, access terminal, user terminal, terminal device, or user equipment (UE). The user device may correspond to one of the user devices 100, 102 of FIG. 1. The network element may correspond to the access node 104 of FIG. 1.

Referring to FIG. 3, in block 301, the apparatus transmits at least one single-carrier waveform symbol comprising at least one of a head sequence and/or a tail sequence, wherein at least a part of the head sequence and/or the tail sequence comprises data and/or control information. For example (in uplink scenario), the control information may comprise uplink control information (UCI), and the data may comprise physical uplink shared channel (PUSCH) data. As another example (in downlink scenario), the control information may comprise downlink control information (DCI), and the data may comprise physical downlink shared channel (PDSCH) data. The head sequence and/or the tail sequence may further comprise one or more reference sub-symbols known at the receiver of the transmission.

In one example, the at least one single-carrier waveform symbol may be transmitted using frequency domain spectrum shaping with spectrum extension.

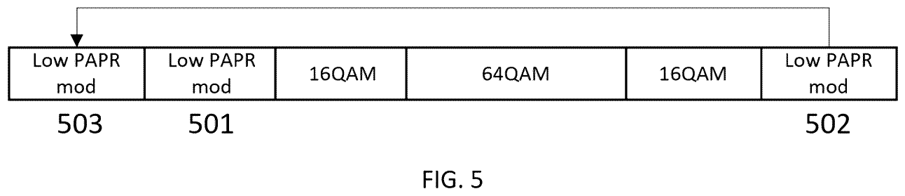

The single-carrier waveform symbol may refer to, for example, a KT-DFT-s-OFDM symbol or a DFT-s-OFDM symbol. Some examples of the at least one single-carrier waveform symbol are shown in FIGS. 5, 9 and 10. For example, the at least one single-carrier waveform symbol may comprise a plurality of different modulation orders, as shown in FIG. 5. However, it should be noted that the single-carrier waveform symbol is not limited to the examples shown in FIGS. 5, 9 and 10.

The at least one of the head sequence and/or the tail sequence may be multiplexed prior to discrete Fourier transform. The at least part of the head sequence and/or the tail sequence may use one of: pi/2 binary phase shift keying modulation, constrained phase shift keying modulation, or Zadoff-Chu sequences. The head sequence and the tail sequence may also be referred to as known sequences herein. The head sequence may refer to a set of sub-symbols at the beginning of the at least one single-carrier waveform symbol, and the tail sequence may refer to a set of sub-symbols at the end of the at least one single-carrier waveform symbol.

FIG. 4 illustrates a flow chart according to an example embodiment of a method performed by an apparatus such as, or comprising, or comprised in, a network element of a radio access network (in uplink scenario) or a user device (in downlink scenario). The network element may correspond to the access node 104 of FIG. 1. The user device may correspond to one of the user devices 100, 102 of FIG. 1.

Referring to FIG. 4, in block 401, the apparatus receives at least one single-carrier waveform symbol comprising at least one of a head sequence and/or a tail sequence, wherein at least a part of the head sequence and/or the tail sequence comprises data and/or control information. For example (in uplink scenario), the control information may comprise uplink control information (UCI), and the data may comprise physical uplink shared channel (PUSCH) data. As another example (in downlink scenario), the control information may comprise downlink control information (DCI), and the data may comprise physical downlink shared channel (PDSCH) data. The head sequence and/or the tail sequence may further comprise one or more reference sub-symbols known at the receiver of the transmission.

The at least part of the known sequence(s) that is used or reserved for data and/or control information may use low-PAPR modulation to optimize the PAPR properties of the KT-DFT-s-OFDM symbol. Some examples of low-PAPR modulation may include (but are not limited to): pi/2 binary phase shift keying (BPSK) modulation, constrained phase shift keying (CPSK) modulation, and Zadoff-Chu sequences. The KT-DFT-s-OFDM symbol may also be referred to as a single-carrier waveform symbol.

The single-carrier waveform symbol may involve multiple different modulation orders within the same symbol. The single-carrier waveform symbol may carry the multiple different modulation orders before the DFT stage in the modulator.

By using proper low-PAPR modulation for the known sequence(s), substantial output power backoff (OBO) gains may be achieved for all of the modulation orders.

The data carried via the known sequence(s) may have better quality compared to that of resource elements (REs) transmitted via regular symbols. This can be leveraged for example when transmitting uplink control signals multiplexed with UL data, as well as in downlink for certain DL control and/or broadcast signaling (i.e., for signaling requiring higher reliability).

For example, the known sequence(s) may be utilized with a certain priority order. One example of such a priority order is presented in the following: HARQ-ACK (if present) is mapped first to the known sequence, rank indicator (if present) is mapped second to the known sequence, CSI (if present) is mapped third to the known sequence, and physical uplink shared channel (PUSCH) data (if present) is mapped fourth to the known sequence.

The at least part of the known sequence reserved for data and/or control information may be configured via downlink control information (DCI), MAC, and/or RRC.

The possible options for the length of the known sequence(s), as well as for the length of the data and/or control information, may follow the rule shown in Table 1 below (assuming that known sequence lengths 4, 16, 64, 128, and 256, i.e., powers of two, are supported as an example). The known sequence length may be chosen according to one of the supported known sequence lengths. That is, the length of the data and/or control information may be equal to the total known sequence length subtracted by the actual known sequence length. The actual known sequence refers to the part of the known sequence that does not carry any data and/or control information. The actual known sequence is mainly used for channel estimation or phase noise compensation, and delay spread protection. It should be noted that even a length of 0 for the actual known sequence may be used, for example when using an artificial intelligence or machine learning receiver, which may be able to compensate the delay spread impact.

TABLE 1

| Total | | |
|---|---|---|
| known | | |
| sequence | | |
| length | Actual known | Low-PAPR |
| (RRC) | sequence length | data/control length |
| 4 | 0, 4 | 4, 0 |
| 16 | 0, 4, 16 | 16, 12, 0 |
| 64 | 0, 4, 16, 64 | 64, 60, 48, 0 |
| 128 | 0, 4, 16, 64, 128 | 128, 124, 112, 64, 0 |
| 256 | 0, 4, 16, 64, 128, 256 | 256, 252, 240, 192, 128, 0 |

However, other lengths may also be possible, and thus some example embodiments are not limited to the options presented in Table 1.

The user device may be configured to have mixed modulation and coding schemes (MCS). The beginning (head) and end (tail) of the single-carrier waveform symbol may comprise a number of data sub-symbols using lower-order modulation (these data sub-symbols may be part of the known sequence). The rest of the single-carrier waveform symbol may use higher order modulation (or alternatively the same modulation as the beginning and end). Thus, the user device may be configured with at least two different MCS indices.

As an example, there may be X data sub-symbols for a first lower-order modulation, and Y data sub-symbols for a second modulation order, where the time-domain distribution within the single-carrier waveform symbol may be pre-defined. For example, X/2 sub-symbols may be at the beginning (corresponding to the lower order modulation), Y/2 sub-symbols may be next, then Y/2, and finally X/2. Alternatively, the specific time-domain distribution may be signaled.

As another example, there may be X data sub-symbols for a first lower-order modulation, Y data sub-symbols for a second modulation order, and Z data sub-symbols for a third modulation order, where the time-domain distribution within the single-carrier waveform symbol may be pre-defined. For example, X/2 sub-symbols may be at the beginning (corresponding to the lower order modulation), Y/2 sub-symbols may be next, then Z, then Y/2, and finally X/2. The third modulation order may be used to further decrease OBO and/or MPR.

As another example, there may be first KT sub-symbols as reference sub-symbols, then data sub-symbols, and then higher order modulation.

FIG. 5 illustrates an example of mixed modulations within a KT-DFT-s-OFDM symbol, wherein two different modulations (16QAM and 64QAM) are used in the data part (QAM is an abbreviation for quadrature amplitude modulation). The head sequence 501 refers to the head samples of the KT, and the tail sequence 502 refers to the tail samples of the KT. At least a part of these head samples 501 and tail samples 502 may be reserved to carry data and/or control information. It should be noted that the CP 503 may be optional. The CP 503 may carry the same samples as the tail sequence 502. The length of the tail sequence 502 may be the same as the CP length, or it may be different than the CP length. The head sequence 501 may be avoided, if the CP 503 is used at the beginning of the KT-DFT-s-OFDM symbol.

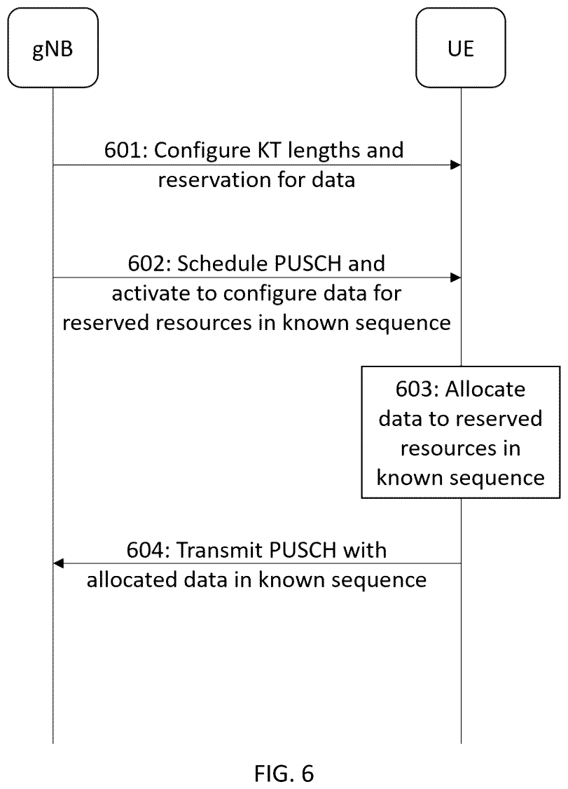

FIG. 6 illustrates a signaling diagram according to an example embodiment. Even though FIG. 6 illustrates an uplink scenario (PUSCH), it may also be applied for downlink.

Referring to FIG. 6, in block 601, a network element of a radio access network transmits to a user device a configuration indicating known sequence lengths and a reservation for free use. In other words, the configuration may indicate the length of a head sequence and/or a tail sequence of at least one single-carrier waveform symbol, as well as at least a part of the head sequence and/or the tail sequence reserved for data and/or control information. The configuration may further indicate whether the at least part of the head sequence and/or the tail sequence is comprised in a same transport block or in a different transport block compared to a central part of the at least one single-carrier waveform symbol. The configuration may further indicate a modulation and coding scheme to be used for one or more transport blocks within the at least one single-carrier waveform symbol. The configuration may be transmitted via RRC signaling, for example.

The network element may be, for example, an access node such as a gNB.

In block 602, the network element schedules (e.g., via DCI) PUSCH for the user device and indicates activation to configure data and/or control information for reserved resources in the known sequence(s). The activation means that the user device is allowed to use the at least part of the head sequence and/or the tail sequence for data and/or control information.

In block 603, the user device allocates data and/or control information to the reserved resources in the at least part of the head and/or tail sequence of the at least one single-carrier waveform symbol based on the configuration.

In block 604, the user device transmits, to the network element, PUSCH with the allocated data and/or control information in the at least part of the head and/or tail sequence of the at least one single-carrier waveform symbol.

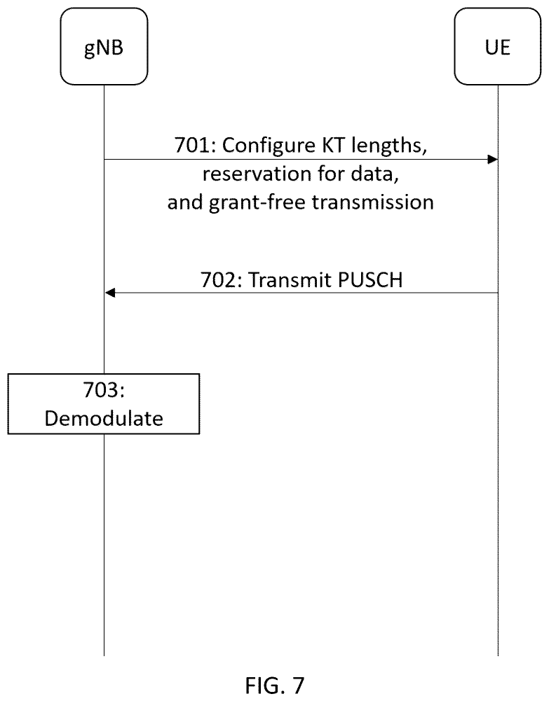

FIG. 7 illustrates a signaling diagram according to another example embodiment. Even though FIG. 7 illustrates an uplink scenario (PUSCH), it may also be applied for downlink.

Referring to FIG. 7, in block 701, a network element of a radio access network transmits to a user device a configuration with known sequence lengths, a reservation for free use, and grant-free UL transmission. In other words, the configuration may indicate the length of a head sequence and/or a tail sequence of at least one single-carrier waveform symbol, as well as at least a part of the head sequence and/or the tail sequence reserved for data and/or control information. The configuration may further indicate whether the at least part of the head sequence and/or the tail sequence is comprised in a same transport block or in a different transport block compared to a central part of the at least one single-carrier waveform symbol. The configuration may further indicate a modulation and coding scheme to be used for one or more transport blocks within the at least one single-carrier waveform symbol. The configuration may be transmitted via RRC signaling, for example.

The grant-free UL transmission means that the user device does not need to wait for a separate activation or indication from the network element to transmit the data and/or the control information in the head sequence and/or the tail sequence. The grant-free transmission may be scheduled via RRC (semi-persistent allocation), or it may be configured via RRC and activated/deactivated via MAC.

The network element may be, for example, an access node such as a gNB.

In block 702, the user device transmits, to the network element, PUSCH with data and/or control information in the at least part of the head and/or tail sequence of the at least one single-carrier waveform symbol. The user device may also indicate activation to configure data and/or control information for the reserved resources in the known sequence(s). This may be indicated for example in uplink control information or in the known sequence itself.

In block 703, the network element demodulates the PUSCH. The network element may also check the activation prior to the demodulation to determine whether the user device has used the known sequence(s) to carry data and/or control information. For example, the user device may indicate the activation to the network element by using data-associated control signaling, such as demodulation reference signal (DMRS) sequence selection. Alternatively, checking the activation may mean that the network element detects whether the user device transmitted anything or not. For example, in the grant-free case, the user device may not transmit anything.

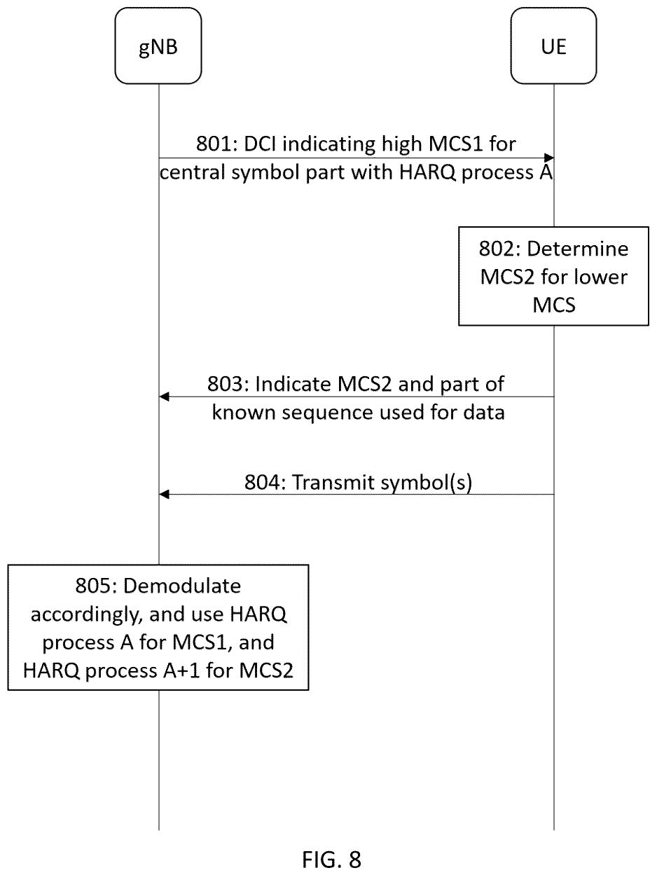

FIG. 8 illustrates a signaling diagram according to another example embodiment, wherein at least two different MCSs are associated with different transport blocks (TBs) and different hybrid automatic repeat request (HARQ) processes (multi-TB scheduling). This may allow optimization of the transmission separately for different MCS parts.

Referring to FIG. 8, in block 801, a network element of a radio access network transmits, to a user device, DCI indicating a first MCS (MCS1) with higher-order modulation for a central part of a single-carrier waveform symbol with HARQ process A. The network element may be, for example, an access node such as a gNB.

In block 802, the user device determines a second MCS (MCS2) for lower-order modulation, i.e., head and tail sequence of the single-carrier waveform symbol. The user device may determine the second MCS implicitly from that of the first MCS (→HARQ process A+1). The DCI may comprise a new data indicator (NDI) separately for both HARQ processes. In other words, there may be separate HARQ-ACK feedback for both HARQ processes.

In block 803, the user device may indicate, to the network element, the at least part of the head and/or tail sequence comprising data and/or control information, as well as the determined second MCS used for the data and/or the control information.

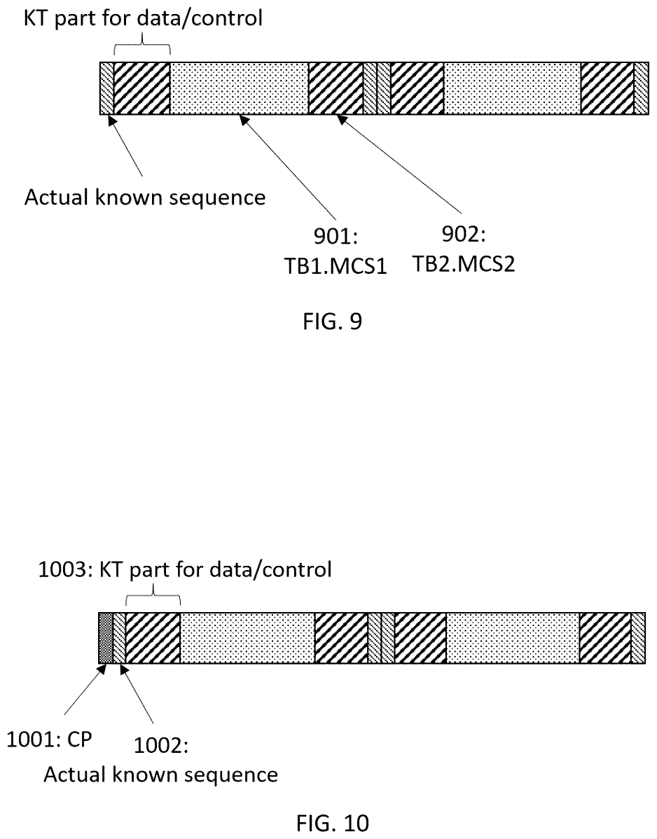

In block 804, the user device transmits at least one single-carrier waveform symbol, i.e., the scheduled data containing the two MCSs, to the network element. The head sequence and/or the tail sequence uses the lower-order modulation (MCS2), and the central part of the single-carrier waveform symbol uses the higher-order modulation (MCS1). An example of the single-carrier waveform symbol is shown in FIG. 9. The transmission may also include transport format related information. For example, MCS2 may be up to the user device to decide.

In block 805, the network element demodulates the single-carrier waveform symbol(s) accordingly. The data and/or the control information may be demodulated based at least partly on the indication that may be received from the user device. The network element uses HARQ process A for the first MCS, and HARQ process A+1 for the second MCS.

The blocks, related functions, and information exchanges (messages) described above by means of FIGS. 3-4 and 6-8 are in no absolute chronological order, and some of them may be performed simultaneously or in an order differing from the described one. Other functions can also be executed between them or within them, and other information may be sent, and/or other rules applied. Some of the blocks or part of the blocks or one or more pieces of information can also be left out or replaced by a corresponding block or part of the block or one or more pieces of information.

FIG. 9 illustrates an example of a single-carrier waveform symbol, wherein different MCSs are part of different transport blocks (TBs). In FIG. 9, a first MCS (MCS1) is part of a first TB (TB1) 901. A second MCS (MCS2) is part of a second TB (TB2) 902. In other words, the two TBs refer to two time-division multiplexed transport blocks within a single-carrier waveform symbol.

It should be noted that there may also be additional TBs (on top of the two TBs) transmitted in parallel with one or more TBs within the single-carrier waveform symbol (i.e., additional MIMO layers) multiplexed spatially.

Alternatively, different MCSs may be associated with the same TB (i.e., there are no time-division multiplexed transport blocks within a single-carrier waveform symbol). In this case, this may have an impact on the transport block size definition. In some example embodiments, the number of information bits (N_info) may be calculated as N_info=sum_i (N_RE_i*R_i*Q_m, i)*v, where i goes over the different modulation orders defined for a symbol. N_RE is the number of resource elements, R_i is the coding rate, Q_m is the modulation order, and v is the number of transmission layers. The error vector magnitude (EVM) requirement may be defined, for example, based on higher order modulation. Alternatively, the EVM requirement may be defined based on a weighted average between the different EVM limits for the modulations used, and the portion they occupy within the symbol. For example, EVM_limit=(L1*X+L2*Y+L3*Z)/(X+Y+Z), where Li is the EVM limit for the modulation order i, and X+Y+Z is the total number of allocated QAM data sub-symbols within a single-carrier waveform symbol. In the example, three modulations are used, but the number of modulations may also be less than three or more than three.

FIG. 10 illustrates an example of a single-carrier waveform symbol, wherein a normal CP 1001 is followed by a known sequence 1002, i.e., a head sequence 1002 adjacent to the CP 1001. The part 1003 in FIG. 10 is the part of the head sequence that is used for data and/or control information. Instead of extended CP, low-order data sub-symbols may be used in the extended CP part also in a legacy DFT-s-OFDM waveform, because they are not so sensitive to errors. In this case, there may be a normal CP 1001, and when extended CP is needed, the known sequence 1002 can be used in addition to the normal CP, to provide more flexibility and avoid use of extended CP. This may provide flexibility, even when some example embodiments are applied on top of a legacy DFT-s-OFDM waveform. In case of normal CP, a slot includes 14 symbols, while extended CP (ECP) results in 12-symbol slots.

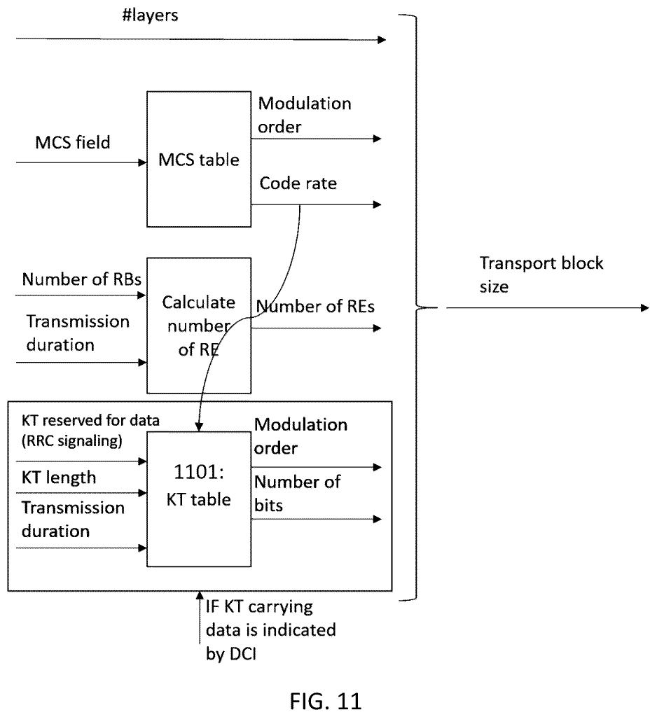

FIG. 11 illustrates an example of how the addition of KT samples carrying data and/or control information affects the transport block size computation. In FIG. 11, the KT table 1101 indicates the modulation order used (e.g., pi/2 BPSK). The sub-symbols reserved for data and/or control information may be indicated by RRC, while the activation of the KT sub-symbols to carry data and/or control information may be indicated in the DCI. The example of FIG. 11 is for the case, where different MCSs are associated with the same TB.

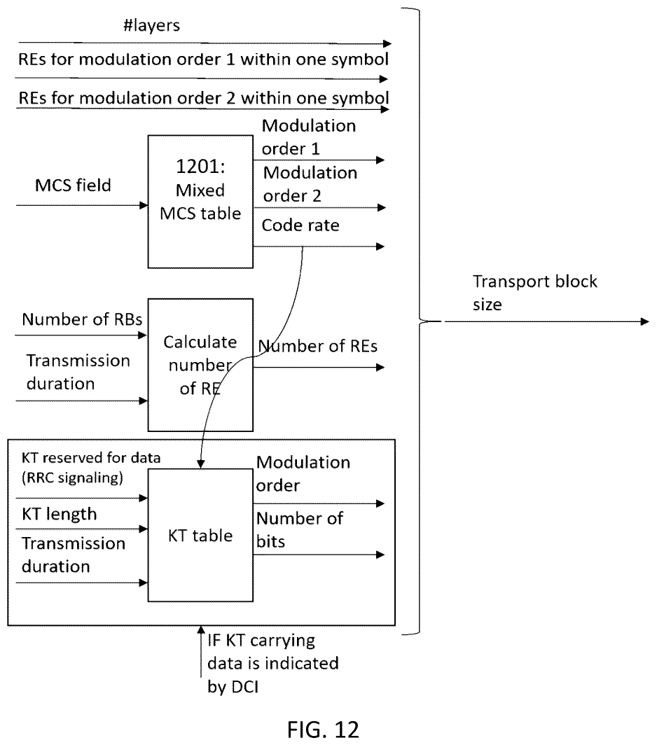

Alternatively, more than one modulation may be used within the data part of the KT-DFT-s-OFDM symbol. FIG. 12 illustrates an example of the transport block size computation, when a mixed MCS table 1201 indicates the modulation order for a first modulation and for a second modulation. The number of REs for modulation order 1 and modulation order 2 (and the position within the KT-DFT-s-OFDM symbol) may be indicated by DCI, or be tabulated as part of the mixed MCS table 1201, for example. This example is for the case, where the different MCSs are associated with the same TB.

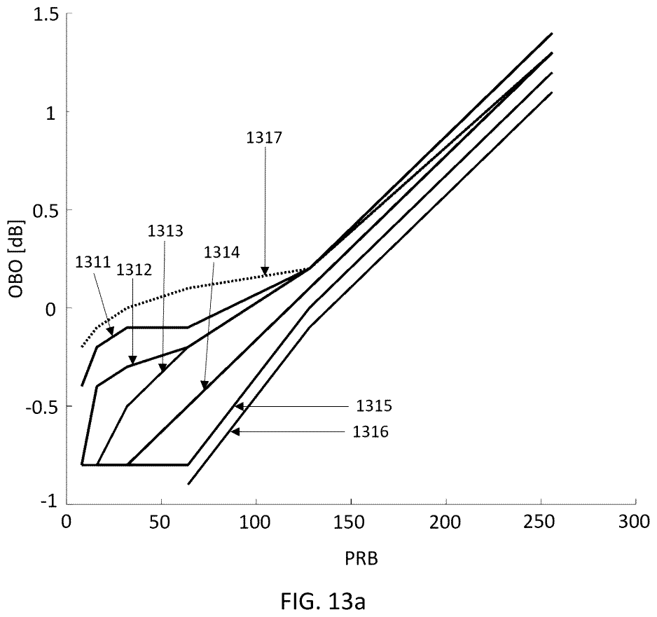

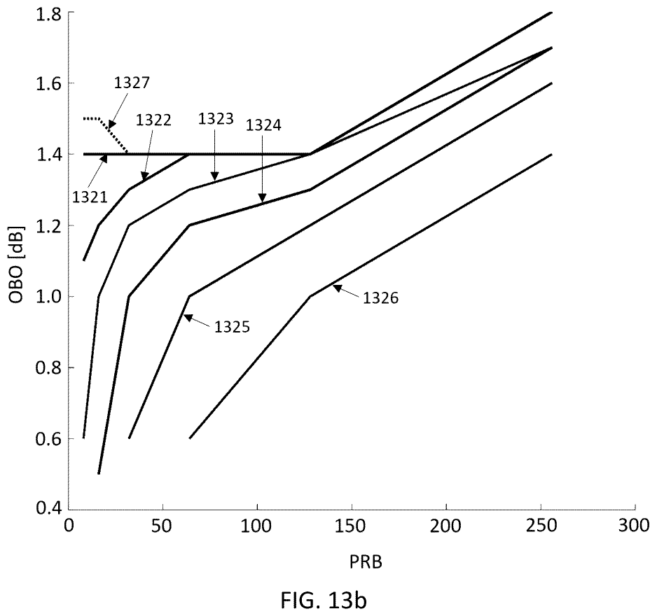

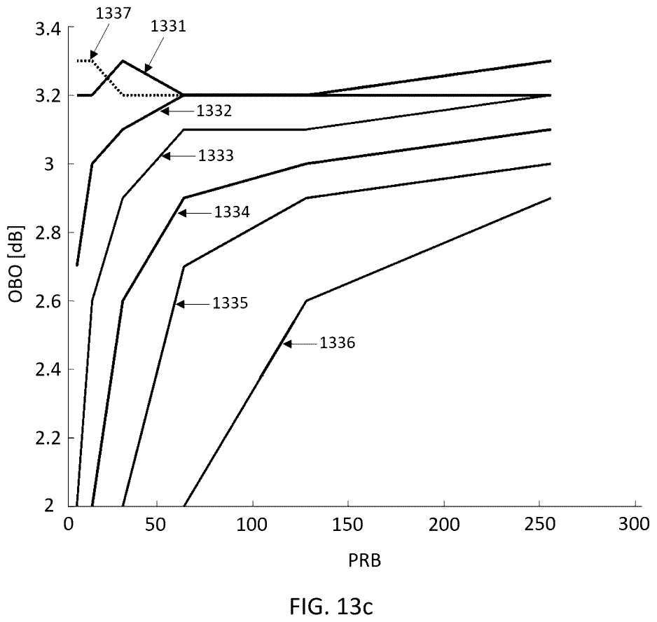

FIGS. 13a, 13b, and 13c illustrate examples of how the known sequence length affects the MPR requirements. The results shown in FIGS. 13a, 13b, and 13c have been obtained after transmitting KT-DFT-s-OFDM waveforms (without FDSS or any other technique to reduce the PAPR of the signal) through a PA model with a carrier frequency of 150 GHz. The FR2 radio frequency (RF) requirements of EVM, in-band emissions (IBE), occupied bandwidth (OBW) and spectrum emission mask (SEM) are considered. The PA output power is gradually increased, while measuring the corresponding PA output signal with respect to the limits set by the RF requirements. The power is increased until at least one of the signal quality metrics is not fulfilled. FIGS. 13a, 13b, and 13c illustrate OBO of the KT-DFT-s-OFDM as a function of known sequence length and allocation size. The OBO is measured with respect to the power class 1 UE from FR2, where negative OBO values mean that the output power is larger than the maximum output power of the UE power class. The known sequences for the tested case are generated by shaping the pi/2-BPSK sequences with the [1+D] filter (this filter combines two consecutive pi/2-BPSK symbols, reducing the PAPR). It can be seen from the figures that increasing the known sequence length, with a proper design of the known sequences, can lead to a large output power increase, when compared to DFT-s-OFDM.

In FIG. 13a, line 1311 represents KT-DFT-s-OFDM QPSK with a known sequence length of 4, line 1312 represents KT-DFT-s-OFDM QPSK with a known sequence length of 16, line 1313 represents KT-DFT-s-OFDM QPSK with a known sequence length of 32, line 1314 represents KT-DFT-s-OFDM QPSK with a known sequence length of 64, line 1315 represents KT-DFT-s-OFDM QPSK with a known sequence length of 128, line 1316 represents KT-DFT-s-OFDM QPSK with a known sequence length of 256, and line 1317 represents DFT-s-OFDM QPSK.

In FIG. 13b, line 1321 represents KT-DFT-s-OFDM 16QAM with a known sequence length of 4, line 1322 represents KT-DFT-s-OFDM 16QAM with a known sequence length of 16, line 1323 represents KT-DFT-s-OFDM 16QAM with a known sequence length of 32, line 1324 represents KT-DFT-s-OFDM 16QAM with a known sequence length of 64, line 1325 represents KT-DFT-s-OFDM 16QAM with a known sequence length of 128, line 1326 represents KT-DFT-s-OFDM 16QAM with a known sequence length of 256, and line 1327 represents DFT-s-OFDM 16QAM.

In FIG. 13c, line 1331 represents KT-DFT-s-OFDM 64QAM with a known sequence length of 4, line 1332 represents KT-DFT-s-OFDM 64QAM with a known sequence length of 16, line 1333 represents KT-DFT-s-OFDM 64QAM with a known sequence length of 32, line 1334 represents KT-DFT-s-OFDM 64QAM with a known sequence length of 64, line 1335 represents KT-DFT-s-OFDM 64QAM with a known sequence length of 128, line 1336 represents KT-DFT-s-OFDM 64QAM with a known sequence length of 256, and line 1337 represents DFT-s-OFDM 64QAM.

Tables 2 to 4 below present the output power gain of KT-DFT-s-OFDM with respect to DFT-s-OFDM for QPSK, 16QAM and 64QAM, giving a quantitative analysis of the achievable gain. PRB is an abbreviation for physical resource block.

Table 2 presents output power gain in dB for KT-DFT-s-OFDM with respect to DFT-s-OFDM for QPSK.

TABLE 2

| KT | | | | | | |
|---|---|---|---|---|---|---|
| length | | | | | | |
| (sub- | PRB allocation | | | | | |
| symbols) | 8 | 16 | 32 | 64 | 128 | 256 |
| 4 | −0.1 | −0.1 | 0 | 0 | 0.1 | −0.1 |
| 16 | 0.4 | 0.1 | 0 | 0.1 | 0 | 0 |
| 32 | 0.6 | 0.3 | 0.2 | 0.2 | 0 | 0 |
| 64 | N/A | 0.7 | 0.5 | 0.2 | 0.1 | 0 |
| 128 | N/A | N/A | 0.8 | 0.4 | 0.2 | 0.1 |
| 256 | N/A | N/A | N/A | 0.8 | 0.3 | 0.2 |

Table 3 presents output power gain in dB for KT-DFT-s-OFDM with respect to DFT-s-OFDM for 16QAM.

TABLE 3

| KT | | | | | | |
|---|---|---|---|---|---|---|
| length | | | | | | |
| (sub- | PRB allocation | | | | | |
| symbols) | 8 | 16 | 32 | 64 | 128 | 256 |
| 4 | 0.1 | 0 | −0.1 | 0 | 0 | 0 |
| 16 | 0.5 | 0.2 | 0 | 0 | 0 | 0.1 |
| 32 | 1.4 | 0.6 | 0.2 | 0 | 0 | 0.1 |
| 64 | N/A | 1.4 | 0.6 | 0.2 | 0.1 | 0.1 |
| 128 | N/A | N/A | 1.3 | 0.6 | 0.2 | 0.2 |
| 256 | N/A | N/A | N/A | 1.3 | 0.6 | 0.4 |

Table 4 presents output power gain in dB for KT-DFT-s-OFDM with respect to DFT-s-OFDM for 64QAM.

TABLE 4

| KT | | | | | | |
|---|---|---|---|---|---|---|
| length | | | | | | |
| (sub- | PRB allocation | | | | | |
| symbols) | 8 | 16 | 32 | 64 | 128 | 256 |
| 4 | 0.1 | 0.1 | −0.1 | 0 | 0 | 0 |
| 16 | 0.6 | 0.3 | 0.1 | 0 | 0 | 0.1 |
| 32 | 1.3 | 0.7 | 0.3 | 0.1 | 0.1 | 0.1 |
| 64 | N/A | 1.3 | 0.6 | 0.3 | 0.2 | 0.2 |
| 128 | N/A | N/A | 1.2 | 0.5 | 0.3 | 0.3 |
| 256 | N/A | N/A | N/A | 1.2 | 0.6 | 0.4 |

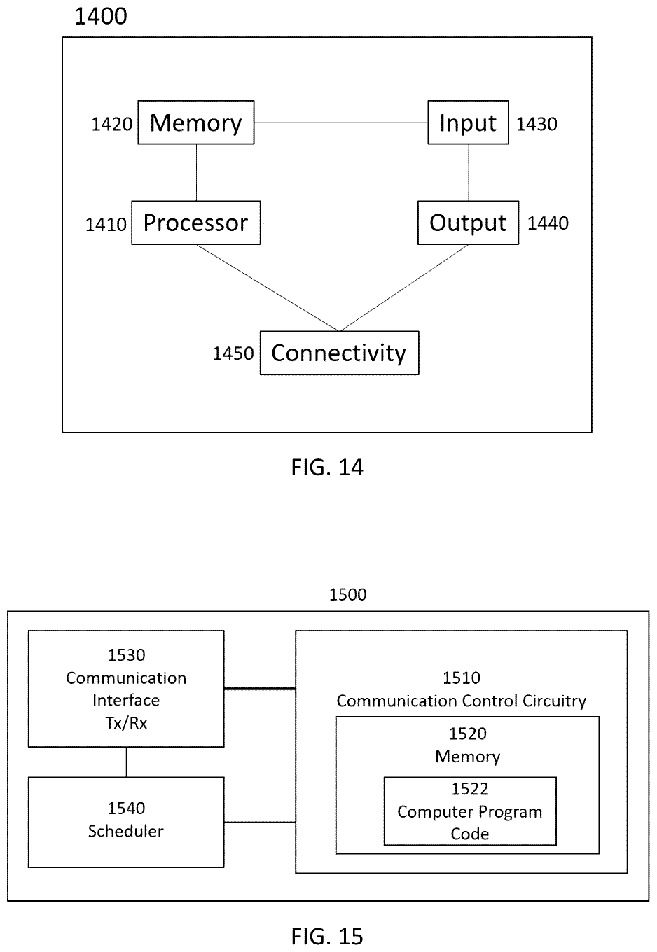

FIG. 14 illustrates an example embodiment of an apparatus 1400, which may be an apparatus such as, or comprising, or comprised in, a user device. The user device may correspond to one of the user devices 100, 102 of FIG. 1. The user device may also be called a subscriber unit, mobile station, remote terminal, access terminal, user terminal, terminal device, or user equipment (UE).

The apparatus 1400 comprises at least one processor 1410. The at least one processor 1410 interprets computer program instructions and processes data. The at least one processor 1410 may comprise one or more programmable processors. The at least one processor 1410 may comprise programmable hardware with embedded firmware and may, alternatively or additionally, comprise one or more application-specific integrated circuits (ASICs).

The at least one processor 1410 is coupled to at least one memory 1420. The at least one processor is configured to read and write data to and from the at least one memory 1420. The at least one memory 1420 may comprise one or more memory units. The memory units may be volatile or non-volatile. It is to be noted that in some example embodiments there may be one or more units of non-volatile memory and one or more units of volatile memory or, alternatively, one or more units of non-volatile memory, or, alternatively, one or more units of volatile memory. Volatile memory may be for example random-access memory (RAM), dynamic random-access memory (DRAM) or synchronous dynamic random-access memory (SDRAM). Non-volatile memory may be for example read-only memory (ROM), programmable read-only memory (PROM), electronically erasable programmable read-only memory (EEPROM), flash memory, optical storage or magnetic storage. In general, memories may be referred to as non-transitory computer readable media. The at least one memory 1420 stores computer readable instructions that are executed by the at least one processor 1410 to perform one or more of the example embodiments described above. For example, non-volatile memory stores the computer readable instructions, and the at least one processor 1410 executes the instructions using volatile memory for temporary storage of data and/or instructions.

The computer readable instructions may have been pre-stored to the at least one memory 1420 or, alternatively or additionally, they may be received, by the apparatus, via an electromagnetic carrier signal and/or may be copied from a physical entity such as a computer program product. Execution of the computer readable instructions causes the apparatus 1400 to perform one or more of the functionalities described above.

In the context of this document, a “memory” or “computer-readable media” or “computer-readable medium” may be any non-transitory media or medium or means that can contain, store, communicate, propagate or transport the instructions for use by or in connection with an instruction execution system, apparatus, or device, such as a computer.

The apparatus 1400 may further comprise, or be connected to, an input unit 1430. The input unit 1430 may comprise one or more interfaces for receiving input. The one or more interfaces may comprise for example one or more temperature, motion and/or orientation sensors, one or more cameras, one or more accelerometers, one or more microphones, one or more buttons and/or one or more touch detection units. Further, the input unit 1430 may comprise an interface to which external devices may connect to.

The apparatus 1400 may also comprise an output unit 1440. The output unit may comprise or be connected to one or more displays capable of rendering visual content, such as a light emitting diode (LED) display, a liquid crystal display (LCD) and/or a liquid crystal on silicon (LCoS) display. The output unit 1440 may further comprise one or more audio outputs. The one or more audio outputs may be for example loudspeakers.

The apparatus 1400 further comprises a connectivity unit 1450. The connectivity unit 1450 enables wireless connectivity to one or more external devices. The connectivity unit 1450 comprises at least one transmitter and at least one receiver that may be integrated to the apparatus 1400 or that the apparatus 1400 may be connected to. The at least one transmitter comprises at least one transmission antenna, and the at least one receiver comprises at least one receiving antenna. The connectivity unit 1450 may comprise an integrated circuit or a set of integrated circuits that provide the wireless communication capability for the apparatus 1400. Alternatively, the wireless connectivity may be a hardwired application-specific integrated circuit (ASIC). The connectivity unit 1450 may comprise one or more components, such as: power amplifier, digital front end (DFE), analog-to-digital converter (ADC), digital-to-analog converter (DAC), frequency converter, (de)modulator, and/or encoder/decoder circuitries, controlled by the corresponding controlling units.

It is to be noted that the apparatus 1400 may further comprise various components not illustrated in FIG. 14. The various components may be hardware components and/or software components.

The apparatus 1500 of FIG. 15 illustrates an example embodiment of an apparatus such as, or comprising, or comprised in, a network element of a radio access network. The network element may correspond to the access node 104 of FIG. 1. The network element may also be referred to, for example, as a network node, a radio access network (RAN) node, a NodeB, an eNB, a gNB, a base transceiver station (BTS), a base station, an NR base station, a 5G base station, an access node, an access point (AP), a relay node, a repeater, an integrated access and backhaul (IAB) node, an IAB donor node, a distributed unit (DU), a central unit (CU), a baseband unit (BBU), a radio unit (RU), a radio head, a remote radio head (RRH), or a transmission and reception point (TRP).

The apparatus 1500 may comprise, for example, a circuitry or a chipset applicable for realizing one or more of the example embodiments described above. The apparatus 1500 may be an electronic device comprising one or more electronic circuitries. The apparatus 1500 may comprise a communication control circuitry 1510 such as at least one processor, and at least one memory 1520 storing instructions which, when executed by the at least one processor, cause the apparatus 1500 to carry out one or more of the example embodiments described above. Such instructions may, for example, include a computer program code (software) 1522 wherein the at least one memory and the computer program code (software) 1522 are configured, with the at least one processor, to cause the apparatus 1500 to carry out some of the example embodiments described above. Herein computer program code may in turn refer to instructions that cause the apparatus 1500 to perform one or more of the example embodiments described above. That is, the at least one processor and the at least one memory 1520 storing the instructions may cause said performance of the apparatus.

The processor is coupled to the memory 1520. The processor is configured to read and write data to and from the memory 1520. The memory 1520 may comprise one or more memory units. The memory units may be volatile or non-volatile. It is to be noted that in some example embodiments there may be one or more units of non-volatile memory and one or more units of volatile memory or, alternatively, one or more units of non-volatile memory, or, alternatively, one or more units of volatile memory. Volatile memory may be for example random-access memory (RAM), dynamic random-access memory (DRAM) or synchronous dynamic random-access memory (SDRAM). Non-volatile memory may be for example read-only memory (ROM), programmable read-only memory (PROM), electronically erasable programmable read-only memory (EEPROM), flash memory, optical storage or magnetic storage. In general, memories may be referred to as non-transitory computer readable media. The memory 1520 stores computer readable instructions that are executed by the processor. For example, non-volatile memory stores the computer readable instructions and the processor executes the instructions using volatile memory for temporary storage of data and/or instructions.

The computer readable instructions may have been pre-stored to the memory 1520 or, alternatively or additionally, they may be received, by the apparatus, via an electromagnetic carrier signal and/or may be copied from a physical entity such as a computer program product. Execution of the computer readable instructions causes the apparatus 1500 to perform one or more of the functionalities described above.

The memory 1520 may be implemented using any suitable data storage technology, such as semiconductor-based memory devices, flash memory, magnetic memory devices and systems, optical memory devices and systems, fixed memory and/or removable memory. The memory may comprise a configuration database for storing configuration data. For example, the configuration database may store a current neighbour cell list, and, in some example embodiments, structures of the frames used in the detected neighbour cells.

The apparatus 1500 may further comprise a communication interface 1530 comprising hardware and/or software for realizing communication connectivity according to one or more communication protocols. The communication interface 1530 comprises at least one transmitter (Tx) and at least one receiver (Rx) that may be integrated to the apparatus 1500 or that the apparatus 1500 may be connected to. The communication interface 1530 may comprise one or more components, such as: power amplifier, digital front end (DFE), analog-to-digital converter ((ADC), digital-to-analog converter (DAC), frequency converter, (de)modulator, and/or encoder/decoder circuitries, controlled by the corresponding controlling units.

The communication interface 1530 provides the apparatus with radio communication capabilities to communicate in the cellular communication system. The communication interface may, for example, provide a radio interface to one or more user devices. The apparatus 1500 may further comprise another interface towards a core network such as the network coordinator apparatus and/or to the access nodes of the cellular communication system.

The apparatus 1500 may further comprise a scheduler 1540 that is configured to allocate radio resources. The scheduler 1540 may be configured along with the communication control circuitry 1510 or it may be separately configured.

It is to be noted that the apparatus 1500 may further comprise various components not illustrated in FIG. 15. The various components may be hardware components and/or software components.

As used in this application, the term “circuitry” may refer to one or more or all of the following: a) hardware-only circuit implementations (such as implementations in only analog and/or digital circuitry); and b) combinations of hardware circuits and software, such as (as applicable): i) a combination of analog and/or digital hardware circuit(s) with software/firmware and ii) any portions of hardware processor(s) with software (including digital signal processor(s), software, and memory(ies) that work together to cause an apparatus, such as a mobile phone, to perform various functions); and c) hardware circuit(s) and/or processor(s), such as a microprocessor(s) or a portion of a microprocessor(s), that requires software (for example firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

The techniques and methods described herein may be implemented by various means. For example, these techniques may be implemented in hardware (one or more devices), firmware (one or more devices), software (one or more modules), or combinations thereof. For a hardware implementation, the apparatus(es) of example embodiments may be implemented within one or more application-specific integrated circuits (ASICs), digital signal processors (DSPs), digital signal processing devices (DSPDs), programmable logic devices (PLDs), field programmable gate arrays (FPGAs), graphics processing units (GPUs), processors, controllers, micro-controllers, microprocessors, other electronic units designed to perform the functions described herein, or a combination thereof. For firmware or software, the implementation can be carried out through modules of at least one chipset (for example procedures, functions, and so on) that perform the functions described herein. The software codes may be stored in a memory unit and executed by processors. The memory unit may be implemented within the processor or externally to the processor. In the latter case, it can be communicatively coupled to the processor via various means, as is known in the art. Additionally, the components of the systems described herein may be rearranged and/or complemented by additional components in order to facilitate the achievements of the various aspects, etc., described with regard thereto, and they are not limited to the precise configurations set forth in the given figures, as will be appreciated by one skilled in the art.

It will be obvious to a person skilled in the art that, as technology advances, the inventive concept may be implemented in various ways. The embodiments are not limited to the example embodiments described above, but may vary within the scope of the claims. Therefore, all words and expressions should be interpreted broadly, and they are intended to illustrate, not to restrict, the example embodiments.

1.-39. (canceled)

40. An apparatus comprising at least one processor, and at least one memory including computer program code, wherein the at least one memory and the computer program code are configured, with the at least one processor, to cause the apparatus to:
transmit, using frequency domain spectrum shaping with spectrum extension, at least one single-carrier waveform symbol without a cyclic prefix to a network element of a radio access network, the at least one single-carrier waveform symbol comprising a head sequence and a tail sequence comprising data including physical uplink shared channel data and control information that includes uplink control information, and wherein:
the head sequence and the tail sequence are multiplexed prior to discrete Fourier transform,
the at least one single-carrier waveform symbol comprises a plurality of different modulation orders,
the at least one single-carrier waveform symbol uses at least two different modulation and coding schemes,
the at least two different modulation and coding schemes are associated with different transport blocks,
the head sequence and the tail sequence uses a lower-order modulation,
a central part of the at least one single-carrier waveform symbol uses a higher-order modulation,
the at least one single-carrier waveform symbol uses at least two different modulation and coding schemes, and
the at least two different modulation and coding schemes are associated with a same transport block; and
transmit, to the network element of the radio access network, an indication indicating the following: a modulation and coding scheme used for the data and the control information, and an at least part of the head sequence and the tail sequence comprising the data and the control information.

41. The apparatus according to claim 40, wherein the at least part of the head sequence and the tail sequence uses one of: pi/2 binary phase shift keying modulation, constrained phase shift keying modulation, or Zadoff-Chu sequences.

42. The apparatus according to claim 41, further being caused to:
receive a configuration indicating the at least part of the head sequence and the tail sequence reserved for the data and the control information.

43. The apparatus according to claim 42, further being caused to:
allocate the data and the control information to the at least part of the head sequence and the tail sequence based on the configuration.

44. The apparatus according to claim 43, wherein the configuration further indicates whether the at least part of the head sequence and the tail sequence is comprised in a same transport block or in a different transport block compared to a central part of the at least one single-carrier waveform symbol.

45. The apparatus according to claim 44, wherein the configuration further indicates a modulation and coding scheme to be used for one or more transport blocks within the at least one single-carrier waveform symbol.

46. The apparatus according to claim 45, wherein the apparatus is a user device.

47. A system comprising:
an apparatus;
at least one processor; and
at least one memory including computer program code, wherein the at least one memory and the computer program code are configured, with the at least one processor, to cause the apparatus to:
transmit, using frequency domain spectrum shaping with spectrum extension, at least one single-carrier waveform symbol without a cyclic prefix to a network element of a radio access network, the at least one single-carrier waveform symbol comprising a head sequence and a tail sequence comprising data including physical uplink shared channel data and control information that includes uplink control information, and wherein:
the head sequence and the tail sequence are multiplexed prior to discrete Fourier transform,
the at least one single-carrier waveform symbol comprises a plurality of different modulation orders,
the at least one single-carrier waveform symbol uses at least two different modulation and coding schemes,
the at least two different modulation and coding schemes are associated with different transport blocks,
the head sequence and the tail sequence uses a lower-order modulation,
a central part of the at least one single-carrier waveform symbol uses a higher-order modulation,
the at least one single-carrier waveform symbol uses at least two different modulation and coding schemes, and
the at least two different modulation and coding schemes are associated with a same transport block; and
transmit, to the network element of the radio access network, an indication indicating the following: a modulation and coding scheme used for the data and the control information, and an at least part of the head sequence and the tail sequence comprising the data and the control information.

48. The system according to claim 47, wherein the at least part of the head sequence and the tail sequence uses one of: pi/2 binary phase shift keying modulation, constrained phase shift keying modulation, or Zadoff-Chu sequences.

49. The system according to claim 48, further being caused to:
receive a configuration indicating the at least part of the head sequence and the tail sequence reserved for the data and the control information.

50. The system according to claim 49, further being caused to:
allocate the data and the control information to the at least part of the head sequence and the tail sequence based on the configuration.

51. The system according to claim 50, wherein the configuration further indicates whether the at least part of the head sequence and the tail sequence is comprised in a same transport block or in a different transport block compared to a central part of the at least one single-carrier waveform symbol.

52. The system according to claim 51, wherein the configuration further indicates a modulation and coding scheme to be used for one or more transport blocks within the at least one single-carrier waveform symbol.

53. The system according to claim 52, wherein the apparatus is a user device.

54. A method comprising:
transmitting, from a user equipment, using frequency domain spectrum shaping with spectrum extension, at least one single-carrier waveform symbol without a cyclic prefix to a network element of a radio access network, the at least one single-carrier waveform symbol comprising a head sequence and a tail sequence comprising data including physical uplink shared channel data and control information that includes uplink control information, and wherein:
the head sequence and the tail sequence are multiplexed prior to discrete Fourier transform,
the at least one single-carrier waveform symbol comprises a plurality of different modulation orders,
the at least one single-carrier waveform symbol uses at least two different modulation and coding schemes,
the at least two different modulation and coding schemes are associated with different transport blocks,
the head sequence and the tail sequence uses a lower-order modulation,
a central part of the at least one single-carrier waveform symbol uses a higher-order modulation,
the at least one single-carrier waveform symbol uses at least two different modulation and coding schemes, and
the at least two different modulation and coding schemes are associated with a same transport block; and
transmitting, from the user equipment to the network element of the radio access network, an indication indicating the following: a modulation and coding scheme used for the data and the control information, and an at least part of the head sequence and the tail sequence comprising the data and the control information.

55. The method according to claim 54, wherein the at least part of the head sequence and the tail sequence uses one of: pi/2 binary phase shift keying modulation, constrained phase shift keying modulation, or Zadoff-Chu sequences.

56. The method according to claim 55, further comprising:
receiving a configuration indicating the at least part of the head sequence and the tail sequence reserved for the data and the control information.

57. The method according to claim 56, further comprising:
allocating the data and the control information to the at least part of the head sequence and the tail sequence based on the configuration.

58. The method according to claim 57, wherein the configuration further indicates whether the at least part of the head sequence and the tail sequence is comprised in a same transport block or in a different transport block compared to a central part of the at least one single-carrier waveform symbol.

59. The method according to claim 58, wherein the configuration further indicates a modulation and coding scheme to be used for one or more transport blocks within the at least one single-carrier waveform symbol.
